(19) United States
(12) Patent Application Publication
(10) Pub. No.: US 2004/0022501 A1
(43) Pub. Date: Feb. 5, 2004

(54) Package casing for fibre-coupled optoelectronic device

(76) Inventors: Yee Loy Lam, Singapore (SG); Siu Chung Tam, Singapore (SG); Kian Hin Victor Teo, Singapore (SG); Hiroshi Nakamura, Singapore (SG)

Correspondence Address: PERMAN & GREEN, 425 POST ROAD, FAIRFIELD, CT, 06824, US

(21) Appl. No.: 10/334,193

(22) Filed: Dec. 31, 2002

(30) Foreign Application Priority Data
Jan. 29, 2002 (GB) 0201990.9

(51) Int. Cl. G02B 6/42

(52) U.S. Cl. 385/92

(57) ABSTRACT

There is provided a casing for packaging a preassembled optical fibre-coupled optoelectronic device assembly. The casing comprises a can having an integrated snout pipe section and an opening extending from the top wall of the can to the snout pipe section for receiving an optical fibre such that the optical fibre can be fitted through the opening into the snout pipe section and so pass through the snout pipe section to the exterior of the casing with the optoelectronic device housed within the can. The opening may be sealed with a removable wall section. Alternatively, when the opening is sufficiently narrow, with solder alone.

### FIELD OF THE INVENTION

The present invention relates to devices for lightwave communications and more specifically to a package casing for housing an optical fibre-coupled optoelectronic device assembly.

### BACKGROUND TO THE INVENTION

One of the key elements in the production of reliable and low cost components for optical communications systems is the testing and packaging of the components in a manufacturing environment. Once an optoelectronic device has been fabricated and tested, it is usually packaged in a protective casing and electrical connections are established via the casing.

Frequently, the optical output of the optoelectronic device is to be coupled into an optical fibre. This will typically be achieved via a butt-coupling arrangement, whereby the fibre is either positioned in close proximity to the output facet of the device itself or to a beam shaping element located between the device and the fibre. The alignment and fixing of an optical fibre with respect to an optoelectronic device is typically performed after the device itself has been packaged. The fibre is fed through an aperture in the casing, accurately positioned for optical coupling and then fixed in position. Typically, the casing features a snout pipe projection through which the fibre passes, rather than a simple clear aperture. The snout pipe acts as an aid to the approximate location of the optical fibre and, in concert with a suitable ferrule located around the protective outer coating of the fibre, provides the means for a firm protective seal for the assembly.

A problem with this approach is that the accurate location of the optical fibre and the testing for low loss coupling is made more difficult by the pre-packaged environment of the optoelectronic device. It would be preferable to align and affix the optical fibre to the optoelectronic device prior to assembly, as both the assembly and testing procedures would thus be simplified. However, the subsequent packaging of the optical fibre and optoelectronic device assembly using existing casing designs would be problematic.

There is therefore a need for a suitable casing to house a preassembled module, comprising an optoelectronic device, any beam shaping elements and an optical fibre, all of which may be located on an optical coupling mount. The resulting package must provide a robust sealed environment for the optical assembly.

### SUMMARY OF THE INVENTION

According to one aspect of the present invention, a casing for packaging a preassembled optical fibre-coupled optoelectronic device assembly, the casing comprising a can having an integrated snout pipe section and an opening extending from the top wall of the can to the snout pipe section for receiving an optical fibre such that the optical fibre can be fitted through the opening into the snout pipe section and so pass through the snout pipe section to the exterior of the casing with the optoelectronic device housed within the can.

The primary part of the casing is the can, which comprises a receptacle fabricated from a rigid material. Preferably, the can is shaped and dimensioned to receive an optoelectronic device and any associated optical coupling mount. Typically, the can will be substantially rectangular.

The wall of the can features an aperture at the location where the optical fibre attached to the optoelectronic device will protrude. Attached to the wall of the can at said location is a hollow protrusion, the “snout pipe”, through which the optical fibre can pass. Also at said location, the wall of the can and the snout pipe are adapted to receive the optical fibre such that it can be substantially centered with respect to the aperture, without feeding it through the aperture and snout pipe.

Preferably, the can and snout pipe comprises a metallic material.

Preferably, the means by which the wall of the can and the snout pipe are adapted to receive the fibre comprises a removable section of the can wall and snout pipe. Once said section has been removed, an opening is provided that is at least sufficiently wide for the fibre to pass through. After locating the optoelectronic device and fibre assembly in the casing, the removable section is replaced and can be sealed by soldering, for example to close the opening.

If the opening left by said section is very narrow, just wider than the fibre diameter for instance, then after placement of the optoelectronic device and fibre assembly the opening can be filled and sealed with a suitable material such as solder, rather than replacing the removable section. Of course, other variations on the basic design are possible, including a plurality of removable sections.

The optical fibre in the assembly will usually have an associated ferrule which is affixed to the fibre so as to surround it. Once the device-fibre assembly has been located in the casing said assembly can be translated such that the ferrule slides into the snout pipe until a stop is encountered. This operation may be performed before or after the removable section(s) is replaced and sealed. The interface between ferrule and snout pipe can also be sealed as required. At this point the optoelectronic device or coupling mount is positioned correctly and can be fixed within the casing and appropriate electrical connections made.

As the ferrule is to be positioned within the snout pipe to form an adequate seal, it is preferred that the snout pipe is shaped and dimensioned so as to receive said ferrule, either before or after relocating any removable sections and sealing thereof. Preferably the completed snout pipe is a cylindrical annulus, although other shapes are possible.

According to another aspect of the present invention, a packaged device comprises a casing, in accordance with the one aspect of the present invention, an optoelectronic device and optical fibre assembly, each of the optical device and optical fibre being located such that the optical fibre passes through the snout pipe section.

### BRIEF DESCRIPTION OF THE DRAWINGS

Examples of the present invention will now be described in detail with reference to the accompanying drawings, in which:

FIG. 1 shows a perspective view of a casing and an optoelectronic device to optical fibre assembly;

FIG. 2 is an end view of an example of a casing according to the present invention;

FIGS. 3A, 3B and 3C show the stages in the packaging of an optical assembly; and,

FIGS. 4A, 4B and 4C show the various methods of sealing the opening in the casing of FIG. 2.

### DETAILED DESCRIPTION

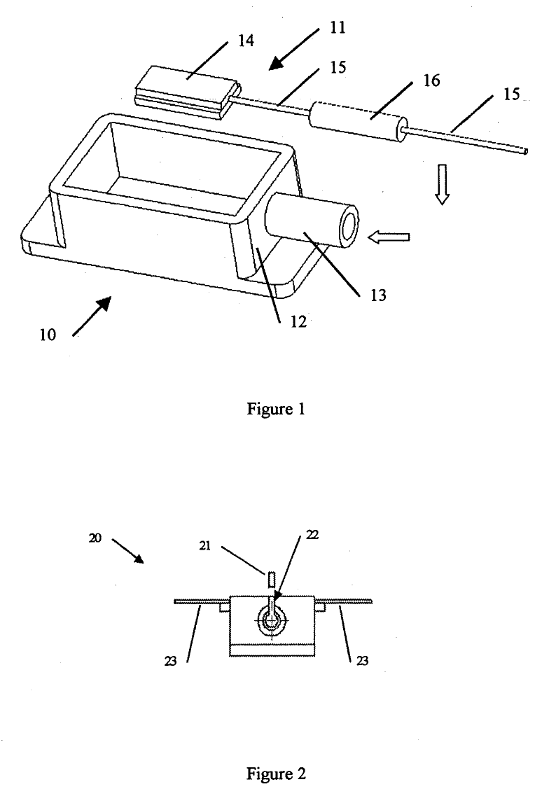

FIG. 1 shows a partial view of a casing 10, for packaging of an optoelectronic device and optical fibre assembly 11, comprising a can 12 with a snout pipe protrusion 13. Also shown is a section of the said assembly 11, including the optoelectronic device 14 with or without a coupling mount, optical fibre 15 and ferrule 16. The outlined arrows indicate the intended location of the ferrule 16. The preassembled module 11 presents a packaging problem when using conventional versions of the casing 10. Typically the device, or mounted device, 14 is too large to fit through the snout pipe 13 and indeed, there will generally be a stop at the can-snout pipe interface for the accurate positioning of the ferrule 16 affixed to the fibre, further limiting access to the casing.

The typical fibre sizes are as follows:

| | |
|---|---|
| Core diameter | 6˜8 mm |
| Cladding diameter | 125 mm |
| Sheath/buffer diameter | 250 mm |
| Fibre jacket diameter | 900 mm |
| Ferrule diameter | 2˜3 mm |

In accordance with the present invention, FIG. 2 shows an end view of an example of a casing 20 which has been designed for simple packaging of a pre-assembled fibre-coupled optoelectronic device. This example features a removable section 21 of the wall of the can and snout pipe which once removed, leaves a sufficiently large opening 22 to permit the placement of the fibre-coupled device assembly. After placement of said assembly, the removable section 21 can be replaced to complete the casing. The opening 22 may be sufficiently small that it can be sealed with solder rather than replacing the removable section 21. Also shown in the Figure are the external electrical connections 23 to the casing.

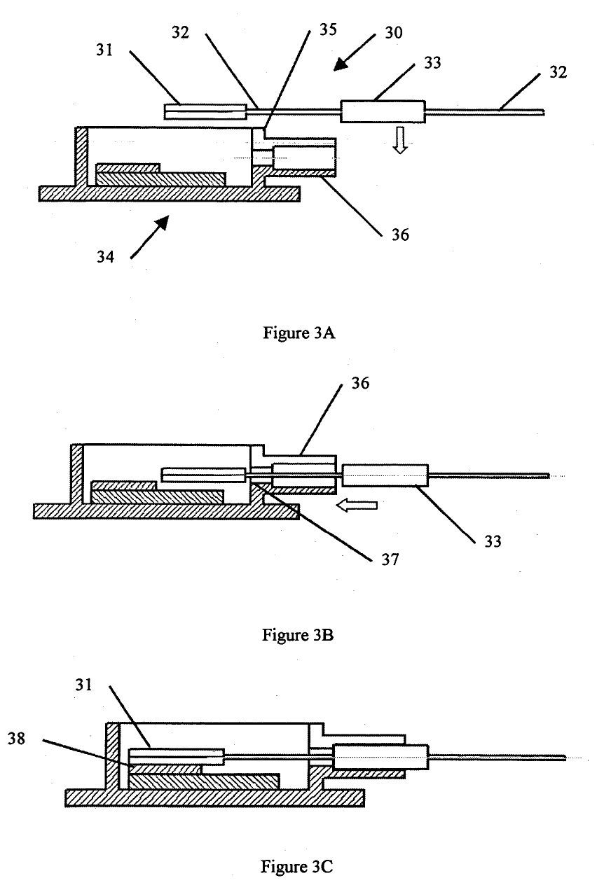

FIGS. 3A, 3B and 3C shows the steps involved in the accurate placement of the fibre-coupled device assembly 30, the outlined arrows indicating the positioning of the assembly. The assembly 30, comprising a mounted optoelectronic device 31, an optical fibre 32 and associated ferrule 33 is positioned in the casing 34 by passing the fibre 32 through an opening in the can wall 35 and snout pipe 36. The assembly is then translated such that the ferrule 33 slides into position inside the snout pipe 36 until a stop 37 is reached. At this point, the optoelectronic device 31 is accurately positioned on a baseplate 38 which may comprise a thermoelectric cooling device.

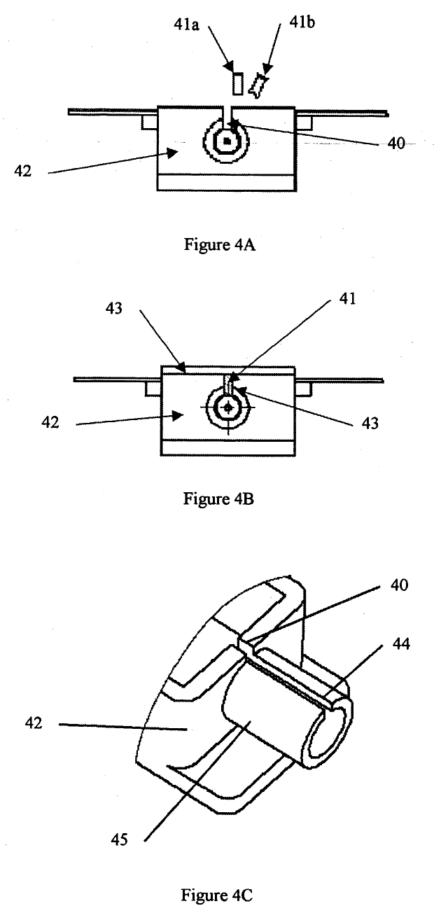

FIGS. 4A, 4B and 4C show examples of methods to seal the narrow opening 40 in the casing of FIG. 2. FIG. 4A shows two types of sealing plate 41 (having a flat tip 41a and a curved tip 41b respectively) for filling the opening 40 in the wall of the can 42. Subsequently, the sealing plate 41 can be fixed in place by solder 43, as shown in FIG. 4B. Alternatively, the opening 40 in the can wall and the opening 44 in the snout pipe 45 can be filled with solder.

Thus the present invention provides a modified casing which permits the simple packaging of a pre-assembled fibre-coupled optoelectronic device. In this way, the fibre coupling of the device can be performed and tested prior to packaging, thereby reducing time and cost in a manufacturing environment. The casing provides a sealed robust package for the assembly that is comparable with other more conventional packages.

1. A casing for packaging a preassembled optical fibre-coupled optoelectronic device assembly, the casing comprising a can having an integrated snout pipe section and an opening extending from the top wall of the can to the snout pipe section for receiving an optical fibre such that the optical fibre can be fitted through the opening into the snout pipe section and so pass through the snout pipe section to the exterior of the casing with the optoelectronic device—housed within the can.

2. A casing according to claim 1, further comprising an initially separate section of the can wall which, when fitted, is shaped to close the opening after insertion of a fibre.

3. A casing according to claim 1, in which the opening is substantially matched to the fibre diameter.

4. A casing according to claim 2, in which the initially separate section is shaped to complete the structure of the snout pipe section.

5. An optical device comprising a casing according to any preceding claim in combination with a preassembled optical fibre-coupled optoelectronic device assembly, the assembly being located such that the optical fibre passes through the snout pipe section.

6. An optical device according to claim 5, in which the opening is closed with an initially separate section of the can wall and snout pipe section fitted within the opening.

7. A packaged device comprising a casing according to any preceding claim, an optoelectronic device and optical fibre assembly, the optoelectronic device and optical fibre assembly being located such that the optical fibre passes through the snout pipe section of the casing.

8. A method of assembling an optical device comprising the steps of providing a casing for packaging a preassembled optical fibre-coupled optoelectronic device assembly, the casing comprising a can having an integrated snout pipe section and an opening extending from the top wall of the can to the snout pipe section for receiving an optical fibre such that the optical fibre can be fitted through the opening into the snout pipe section and so pass through the snout pipe section to the exterior of the casing with the optoelectronic device housed within the can, inserting a pre-assembled module comprising an optoelectronic device and an optical fibre by introducing the module into the can, with fibre passing through the snout pipe section.

9. A method according to claim 8, further comprising the step of closing the opening using an initially separate section of the can wall.
